(19) United States
(12) Patent Application Publication
(10) Pub. No.: US 2010/0327491 A1
(43) Pub. Date: Dec. 30, 2010

(54) MOLD FOR INJECTION MOLDING AND MANUFACTURING METHOD OF INJECTION-MOLDED PRODUCT

(75) Inventor: Hiroaki Nagashima, Shizuoka (JP)

Correspondence Address: MCDERMOTT WILL & EMERY LLP, 600 13TH STREET, N.W., WASHINGTON, DC, 20005-3096, US

(73) Assignee: SUZUKI MOTOR CORPORATION, Shizuoka (JP)

(21) Appl. No.: 12/822,619

(22) Filed: Jun. 24, 2010

(30) Foreign Application Priority Data
Jun. 25, 2009 (JP) 2009-151564

(51) Int. Cl. B29C 45/18; B29C 45/27

(52) U.S. Cl. 264/328.1; 425/567

(57) ABSTRACT

A provisional rib portion is formed in a connected manner at a predetermined portion of a cavity to correspond to a provisional rib which is formed to project from a portion, of an injection-molded product, not serving as a design surface, and resin is injected for molding to the provisional rib portion via a gate. An end portion of the design surface of the injection-molded product is set on a parting line, and the provisional rib portion is formed in a connected manner, on a cavity surface along the parting line, by being sided to an inner side from the design surface, and a part or all on the design surface side of a connecting portion at which the provisional rib portion and the cavity are connected is formed in a curved shape.

### CROSS-REFERENCE TO RELATED APPLICATIONS

This application is based upon and claims the benefit of priority of the prior Japanese Patent Application No. 2009-151564, filed on Jun. 25, 2009, the entire contents of which are incorporated herein by reference.

### BACKGROUND OF THE INVENTION

1. Field of the Invention

The present invention relates to a mold for injection molding and a manufacturing method of an injection-molded product, and particularly relates to a technique for improving a quality of outer appearance of the injection-molded product.

2. Description of the Related Art

In recent years, in an interior of automobile, for instance, resin parts painted in a silver metallic color have been increasingly adopted for improving design. However, in painting process, volatile organic compounds (hereinafter, referred to as VOC) contained in the paint may be emitted into the atmosphere, and further, the VOC ascribable to the paint may be generated in a vehicle interior. Accordingly, it is desired to mold colored resins into which coloring agent and luminous agent are previously kneaded, instead of performing painting.

So far, there have been a large number of examples where unpainted interior parts of automobile in a solid color such as black color and white color are actually used. However, regarding the unpainted interior parts in silver metallic color, since the parts sometimes bear, on outer surfaces thereof, black-streaks called weld lines due to a luminous material such as aluminum powder or mica powder contained in resin, and thus there are very few cases where the interior parts are actually commercialized.

Although it is also desired not to perform painting in silver metallic color on an audio volume knob, for instance, it was difficult to be realized since the weld lines are sometimes generated in the vicinity of a gate. This is due to a gate structure when the volume knob is injection-molded.

In FIGS. 7, FIG. 7A is a view showing a cross section of a mold having an overlap gate, and FIG. 7B is a view showing a volume knob molded by the mold having the overlap gate.

The mold having the overlap gate as shown in FIG. 7A is composed of a die 61 (movable side or fixed side) and the other die 62 (fixed side or movable side), and a cavity 64 is formed by closing these dies along a parting line 63. Further, molten resin is injected to fill the cavity 64 from a runner 65 via an overlap gate 66, to thereby perform molding.

The volume knob being a molded product shown in FIG. 7B has a box shape or a bottomed cylindrical shape, and in order to realize simplicity of machining of dies and not to leave a trace of gate-cut on a design surface, it is common that the resin is filled into the cavity 64 via the overlap gate 66 as shown in FIG. 7A. However, if the overlap gate 66 is employed, weld lines (WL) are generated from a corner portion of an abutting surface at which a gate portion 67 formed of the overlap gate 66 and a molded product main body 68 abut, as shown in an enlarged view in FIG. 7B. This is because the flow of the injected resin is branched at a corner portion of a connecting portion at which the overlap gate 66 and the cavity 64 are connected (arrows in FIG. 7B), the resin collides at a design surface (outer surface) of the molded product main body 68, and orientation of the luminous material such as aluminum powder added to the resin occurs.

Here, Patent Document 1 (Japanese Patent No. 4120701) discloses that, by rounding a corner portion of a side gate, it is possible to prevent the generation of weld lines starting from the corner portion.

[Patent Document 1] Japanese Patent No.

[Patent Document 2] Japanese Laid-open Patent Publication No. 08-41284

[Patent Document 3] Japanese Patent No. 3571403

However, in a structure disclosed in Patent Document 1, since the side gate is disposed at a position corresponding to a side surface portion of a molded product, a product such as a volume knob bears a trace of gate-cut on its design surface, and thus it cannot be used as a marketable product, although the generation of weld lines can be prevented. Further, if the overlap gate is employed, a corner portion of a connecting portion at which the overlap gate is connected to a cavity cannot be rounded due to the presence of undercut because of its structural reason, and thus the problem of the weld lines cannot be solved.

As a measure other than the one relying on the gate structure, there is a measure relying on a material. For example, in Patent Document 2 (Japanese Patent Application Laid-open No. Hei 8-41284), the generation of weld lines is reduced by selecting the shape or grain size of a luminous material added to a resin material. Further, in Patent Document 3 (Japanese Patent No. 3571403), the generation of weld lines is reduced by selecting a grain size and an addition amount of a luminous material and by adding titanium oxide, zinc oxide or antimony oxide which is called a weld eraser.

However, since the shape, grain size and addition amount of the luminous material are restricted in the techniques disclosed in Patent Document 2 and Patent Document 3, textures such as shiny texture and metallic texture are limitedly produced, resulting in that there are a lot of cases where a highly metallic color tone as an alternative to the texture produced by painting cannot be obtained. Further, these techniques are not capable of completely preventing the generation of weld lines, and cost is increased depending on a blending condition, which is a problem.

### SUMMARY OF THE INVENTION

The present invention has been made in consideration of such circumstances, and an object thereof is to provide a mold for injection molding and a manufacturing method of an injection-molded product capable of providing various types of injection-molded products with high commercial value by improving a quality of outer appearance of the injection-molded product with no restriction on a molding material.

A mold for injection molding of the present invention being a mold for injection molding including a provisional rib portion formed in a connected manner at a predetermined portion of a cavity to correspond to a provisional rib which is formed to project from a portion, of an injection-molded product, not serving as a design surface, and resin is injected for molding to the provisional rib portion via a gate, in which an end portion of the design surface of the injection-molded product is set on a parting line, and the provisional rib portion is formed in a connected manner, on a cavity surface along the parting line, by being sided to an inner side from the design surface, and a part or all on at least the design surface side of a connecting portion at which the provisional rib portion and the cavity are connected is formed in a curved shape.

Further, a manufacturing method of an injection-molded product of the present invention being a manufacturing method of an injection-molded product for injecting resin for molding to a provisional rib portion via a gate, the provisional rib portion being formed in a connected manner at a predetermined portion of a cavity to correspond to a provisional rib which is formed to project from a portion, of the injection-molded product, not serving as a design surface, the method including performing injection molding by using a mold for injection molding having the provisional rib portion formed in a connected manner, by being sided to an inner side from the design surface, on a cavity surface along a parting line on which an end portion of the design surface of the injection-molded product is set, and a connecting portion at which the provisional rib portion and the cavity are connected in which a part or all thereof on at least the design surface side is formed in a curved shape.

### BRIEF DESCRIPTION OF THE DRAWINGS

FIG. 1 is a view showing a mold for injection molding according to an embodiment of the present invention;

FIGS. 2A and 2B are views showing a molded product molded by the mold for injection molding according to the embodiment of the present invention;

FIG. 3 is a view showing a provisional rib portion formed on the mold for injection molding according to the embodiment of the present invention;

FIGS. 4A and 4B are views for explaining a size condition according to examples of the present invention;

FIG. 5 is a view for explaining weld lines and a flow mark generated on a molded product;

FIGS. 6A, 6B and 6C are views showing modified examples of a connecting portion of a provisional rib portion according to the present invention; and

FIGS. 7A and 7B are views showing a mold that employs an overlap gate.

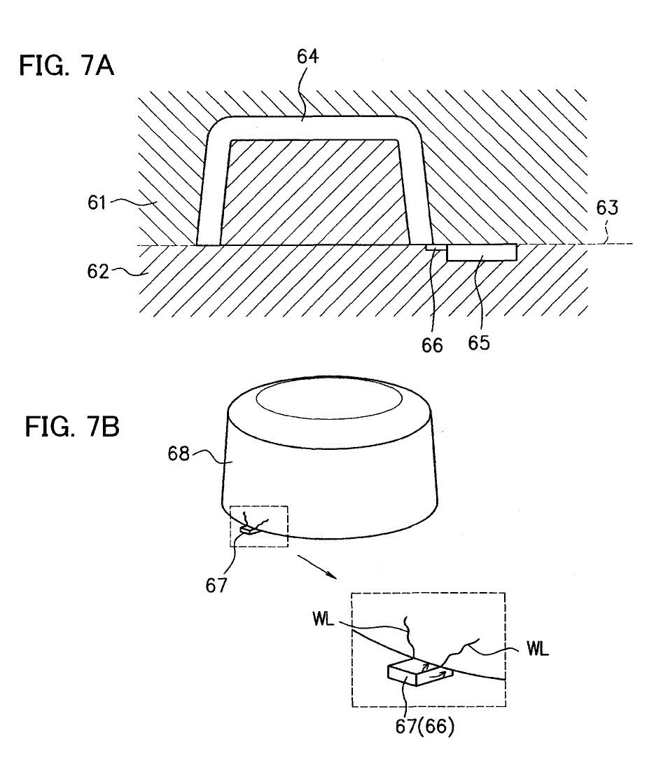

### DETAILED DESCRIPTION OF THE PREFERRED EMBODIMENTS

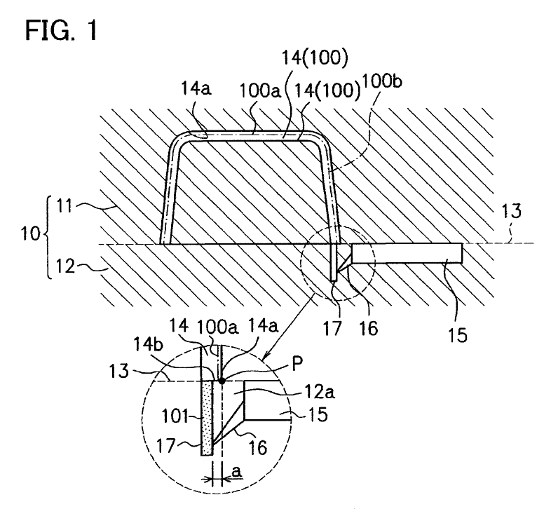

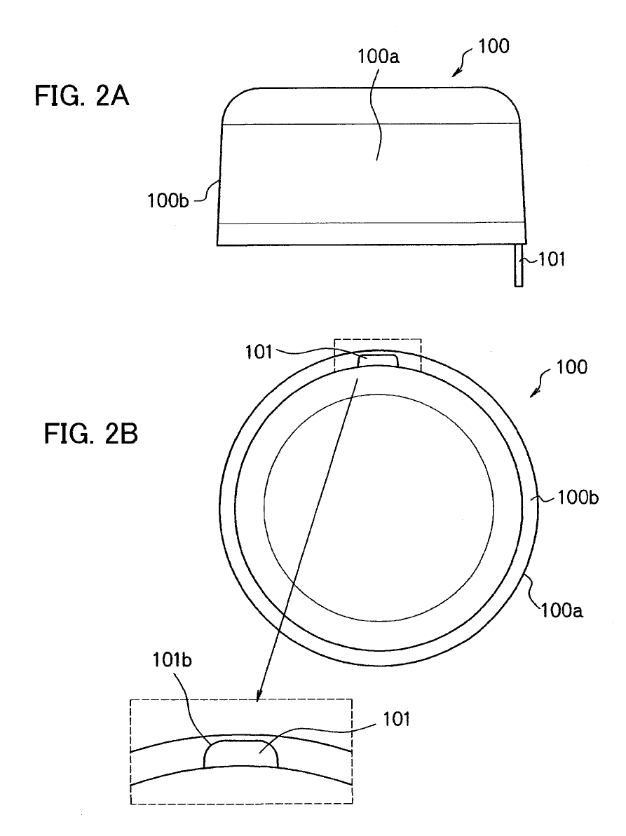

Hereinafter, a preferred embodiment of a mold for injection molding and a manufacturing method of an injection-molded product according to the present invention will be described. FIG. 1 is a view showing a mold for injection molding (hereinafter, referred to as mold) 10 according to the present embodiment, and FIGS. 2A and 2B are views showing a molded product 100 molded (manufactured) by the mold 10.

At first, a schematic structure of the mold 10 according to the present embodiment will be described. As shown in FIG. 1, the mold 10 is composed of a die (movable side or fixed side) and a die 12 (fixed side or movable side), and a cavity 14 is formed by closing these dies along a parting line 13.

A runner 15 is formed along the parting line 13 by being separated from a design surface 100a (one-dot chain line in FIG. 1) of the molded product 100 shown in FIG. 2 formed by the cavity 14, and through which molten resin from a not-shown sprue flows into the cavity 14. More specifically, the molten resin that flows into the cavity 14 through the runner 15 is injected to fill the cavity 14 by passing through a submarine gate 16 and a provisional rib portion 17. As above, the mold 10 has a structure of die employing a so-called submarine gate, so that there is an undercut 12a in the die 12.

In the present embodiment, a product such as an audio volume knob is assumed as a molded product 100 molded by the mold 10, and a molded product 100 having a relatively thin side wall 100b indicated by a dotted line in FIG. 1 and having a box shape or a bottomed cylindrical shape is molded (refer also to FIGS. 2). An outer surface of the molded product 100 is set as a design surface 100a, and an outer surface of the side wall 100b is also included in a part of the design surface 100a. In this case, the design surface 100a is formed by a cavity surface 14a of the cavity 14 having a substantially U-shape in cross section.

Further, in the molded product 100, a provisional rib 101 (enlarged view in FIG. 1) is formed to project from a portion not serving as the design surface 100a, and to correspond to the provisional rib 101, the provisional rib portion 17 is formed in a connected manner at a predetermined portion of the cavity 14 of the mold 10. The provisional rib portion 17 is formed to prevent the generation of weld lines, and is communicated with the runner 15 via the submarine gate 16 to inject the molten resin to fill the cavity 14 (in other words, the provisional rib portion 17 also serves as a gate). Note that the provisional rib portion 17 is formed on the die 12 through cutting or the like, and the provisional rib 101 formed by the provisional rib portion 17 is cut after the molding.

The provisional rib portion 17 will be specifically described. In the present embodiment, an end portion P of the design surface 100a of the molded product 100 is set on the parting line 13, and a surface of a lower end of the side wall 100b of the molded product 100 including the end portion P of the design surface 100a is formed by a cavity surface 14b which is flat along the parting line 13 (enlarged view in FIG. 1). The provisional rib portion 17 is formed in a connected manner at a predetermined position of the cavity surface 14b sided to an inner side from the end portion P of the design surface 100a, namely, at a predetermined position of the cavity surface 14b separated from the end portion P of the design surface 100a by a distance (clearance) a. Note that the clearance a indicates a distance from the design surface 100a to an end portion or an end side of the provisional rib portion 17 that points to the design surface 100a side.

As described above, the mold 10 employs a structure such that the molten resin is injected to fill the provisional rib portion 17 via the submarine gate 16 so that any of the sides of the provisional rib 101 does not overlap with the end portion P of the design surface 100a. Further, with such a structure, weld lines, starting from a corner portion of a connecting portion at which a gate of resin and a cavity are connected, are prevented from being generated on a design surface of a molded product.

Here, the mold 10 in the present embodiment is assumed to mold a relatively thin-walled molded product 100 having a box shape, a bottomed cylindrical shape or the like. In this case, even if the provisional rib portion 17 is provided, due to a restriction on the size condition such as a thickness of the side wall 100b of the molded product 100 and a thickness of the provisional rib portion 17, the clearance a (refer to enlarged view in FIG. 1) being a distance between the provisional rib portion 17 and the design surface 100a sometimes cannot be sufficiently secured, and further, an area of a connecting part at which the provisional rib portion 17 and the cavity 14 are connected (hereinafter, referred to as connecting portion) sometimes cannot be sufficiently secured. If the clearance a cannot be sufficiently secured, even when the provisional rib portion 17 is provided, a weld line (WL) starting from the provisional rib portion 17 may be generated on the design surface 100a, and further, if the area of the connecting portion between the provisional rib portion 17 and the cavity 14 cannot be sufficiently secured, an outer appearance such as flow mark (FM) and jetting may appear on the design surface 100a. Note that the flow mark and the jetting are easily generated as the area of gate (connecting portion between the provisional rib portion 17 and the cavity 14, in this case) becomes smaller, and are one of defects in outer appearance.

However, when the molded product 100 has a thin wall, there are generated contradictory relations such that if the clearance a of the provisional rib portion 17 is tried to be sufficiently secured, the area of the connecting portion at which the provisional rib portion 17 and the cavity 14 are connected cannot be sufficiently secured, and if the area of the connecting portion is tried to be sufficiently secured, the clearance a cannot be sufficiently secured. Further, when the both relations cannot be satisfied, the quality of outer appearance of the molded product 100 cannot be assured, and a necessity of applying painting and the like is generated, which may lead to an increase in cost.

Therefore, in the mold 10 according to the present invention, a part or a front portion on at least the design surface 100a side of the connecting portion at which the provisional rib portion 17 and the cavity 14 are connected is formed in a curved shape. In this embodiment, arc-shaped corner portions (namely, rounded corner portions) are provided to form the curved shape, and by rounding corner portions on at least the design surface 100a side of the connecting portion, the quality of outer appearance is improved even when the clearance a and the area of the connecting portion cannot be sufficiently secured. Note that as the curved shape, not only the one formed by the arc-shaped corner portions but also an elliptical shape or a circular shape and the like can be selected, as will be described later.

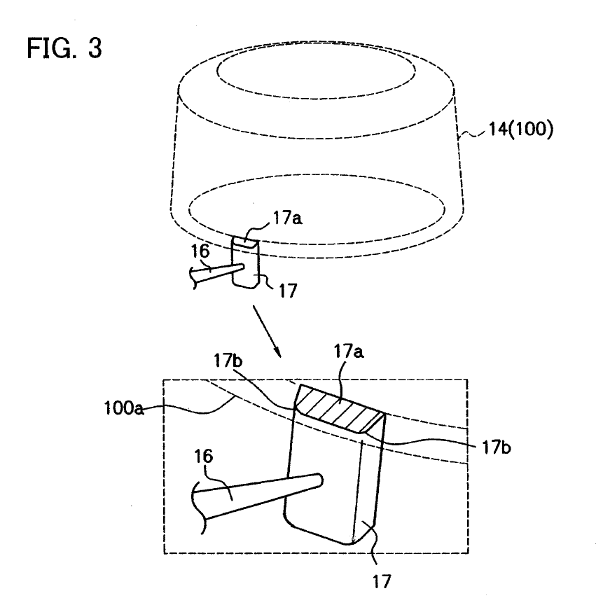

In FIGS. 2, FIG. 2A shows a front view of the molded product 100, and FIG. 2B shows a bottom view. Further, FIG. 3 is a perspective view showing the cavity 14 and the provisional rib portion 17.

Here, it is set that the connecting portion between the provisional rib portion 17 and the cavity 14 is a boundary area between the both along the parting line 13 (strictly, boundary surface; parting surface). As also shown in FIG. 1 and the like, the provisional rib portion 17 has a predetermined length in a direction in which the mold is opened/closed (longitudinal direction in FIG. 1), and corner portions in a longitudinal direction thereof are not rounded, namely, only the corner portions at the aforementioned boundary area are rounded to form the connecting portion.

Specifically, in the molded product 100, the corner portions positioned on the design surface 100a side of the provisional rib 101 are rounded, namely, formed in an arc shape (101b), as shown in FIG. 2B. In accordance with this, in the provisional rib portion 17, the corner portions on the design surface 100a side of the connecting portion 17a being a connecting part between the provisional rib portion 17 and the cavity 14 are rounded (R portions 17b), as shown in FIG. 3.

As described above, in the mold 10, by forming the R portions 17b by rounding the corner portions on the design surface 100a side of the connecting portion 17a between the provisional rib portion 17 and the cavity 14 so that they are formed in a curved shape, even when the clearance a cannot be sufficiently secured due to the wall thickness of the molded product 100, the quality of outer appearance is assured. Specifically, by forming the R portions 17b to make the flow of the molding material smooth, the generation of weld lines is prevented, and the quality of outer appearance of the molded product 100 is assured.

As described above, in the mold 10 according to the embodiment of the present invention, the R portions 17b are formed by rounding the corner portions on the design surface 100a side of the connecting portion 17a between the provisional rib portion 17 and the cavity 14 so that they are formed in a curved shape. As a result of this, even when the clearance a cannot be sufficiently secured due to the wall thickness of the molded product 100, the generation of weld lines is surely prevented by making the flow of the molding material smooth with the use of the R portions 17b.

Further, the mold 10 according to the present embodiment can be effectively utilized particularly when the area of the connecting portion 17a between the provisional rib portion 17 and the cavity 14 cannot be sufficiently secured if a thickness b of the provisional rib portion 17 is reduced to secure the clearance a due to the shape of the molded product 100. Specifically, by forming the R portions 17b, the generation of weld lines can be prevented without reducing the thickness of the provisional rib portion 17 to secure the clearance a, so that the area at the connecting portion 17a can be sufficiently secured, which results in preventing the generation of flow mark and jetting, in addition to the weld lines.

Further, in the mold 10 according to the present embodiment, since the molding material filled in the submarine gate 16 is automatically cut when the mold is opened, only one cutting process of the provisional rib 101 is necessary, so that when compared with a case in which the overlap gate is employed, there is no increase in the number of cutting processes. Accordingly, cost reduction can be practically realized while improving the quality of outer appearance.

Further, the mold 10 according to the present embodiment realizes the assurance of the quality of outer appearance from the structural aspect, so that it is applicable to a case where a resin material containing a luminous material such as aluminum powder or mica powder and thus having high metallic texture, which has been difficult to be mass-produced, is used, and there is no restriction on the shape, grain size and addition amount of the luminous material, which makes it possible to provide various types of molded products with high commercial value. Further, with the use of the mold 10 according to the present embodiment, since the necessity of painting can be eliminated, a cost-down effect can be obtained, and a significant contribution to the environment is made because of the reduction in VOC.

### Examples

Hereinafter, examples of the present invention will be described together with comparative examples. In the present examples and the comparative examples, audio volume knobs each having a side wall whose wall thickness (plate thickness) is 2.0 mm and having a box shape or a bottomed cylindrical shape are molded. In the examples, the mold according to the present invention in which the provisional rib portion 17 is provided and the corner portions of the connecting portion 17a at which the provisional rib portion 17 and the cavity 14 for forming the volume knob are connected are rounded, is used. Meanwhile, in the comparative examples, a mold having a submarine gate in which a provisional rib portion is provided and corner portions of a connecting portion between the provisional rib portion and a cavity are not formed in a curved shape, namely, the connecting portion is formed in a rectangular shape, is used.

Further, as a molding material in the present examples and the comparative examples, AES resin is selected, and the resin to which 2.0 weight percent of aluminum powder having an average grain size of 5 μm is added, is used. Note that in general, aluminum powder has an average grain size of 5 μm to 90 μm, in which there is a characteristic such that as the grain size is smaller, a high metallic texture can be obtained and a design is improved, but, an outer appearance such as a weld line and a flow mark is easily generated.

### Comparative Example

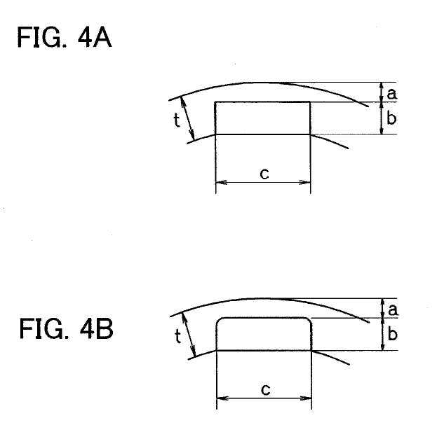

At first, the comparative examples will be explained. As described above, in the comparative examples, there is used the mold having the submarine gate in which the provisional rib portion is provided and the corner portions of the connecting portion between the provisional rib portion and the cavity are not formed in a curved shape, namely, the connecting portion is formed in a rectangular shape. FIG. 4A shows a shape of the provisional rib portion of the mold according to the comparative examples or a provisional rib formed on the volume knob. As shown in FIG. 4A, in the mold according to the comparative examples, the connecting portion between the provisional rib portion and the cavity has a rectangular shape. In the comparative examples, the volume knobs are molded using such a mold by setting a wall thickness t of a molded product (side wall) to 2.0 mm and a width c of the provisional rib portion (connecting portion) to 5.0 mm, while changing a size of the clearance a and a thickness b of the provisional rib portion (connecting portion), and a state of outer appearance is observed. Note that in the volume knobs molded here, the relation of “wall thickness t of molded product=clearance a+thickness b of provisional rib portion” is satisfied. The relation of the state of outer appearance with respect to the respective conditions is shown in Table 1. Note that the reason why the width c of the provisional rib portion is fixed to 5.0 mm in this case is to make it possible to perform the gate-cut with no problem at the time of mass production, and 5.00 mm is set as an upper limit value.

TABLE 1
Relation between clearance a and outer appearance (comparative examples)

| | THICKNESS b OF | WIDTH c OF | | |
|---|---|---|---|---|
| | PROVISIONAL | PROVISIONAL | | |
| CLEARANCE a | RIB PORTION | RIB PORTION | WELD LINE | FLOW MARK |
| 0.2 mm | 1.8 mm | 5.0 mm | GENERATED | NOT GENERATED |
| 0.4 mm | 1.6 mm | 5.0 mm | GENERATED | GENERATED MORE |
| | | | | OR LESS |
| 0.6 mm | 1.4 mm | 5.0 mm | GENERATED | GENERATED |
| 0.8 mm | 1.2 mm | 5.0 mm | GENERATED MORE | GENERATED |
| | | | OR LESS | |
| 1.0 mm | 1.0 mm | 5.0 mm | NOT GENERATED | GENERATED |

As shown in Table 1, it can be confirmed that when the clearance a is small (a=0.2 to 0.8 mm), the weld line is generated, and in order to prevent the generation of weld line, there is a need to set the clearance a to at least 1.00 mm or more.

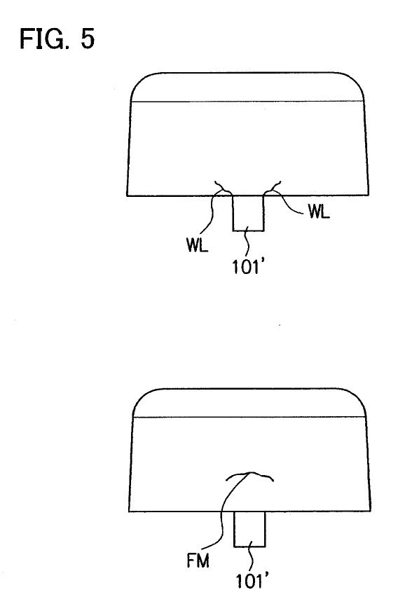

However, it is clarified that when the clearance a is set to 0.4 mm or more, an outer appearance called flow mark (FM, refer to FIG. 5B) is generated, and meanwhile, when the clearance a is set to 0.2 mm, although the weld line (FIG. 5A) is generated, no flow mark is generated. This can be considered because, if the clearance a is set large, namely, if the thickness of the provisional rib portion 17 is reduced under the condition where the wall thickness of the volume knob is thin, the area of the connecting portion between the provisional rib portion 17 and the cavity is reduced, and the molding material does not flow smoothly. Specifically, it is clarified that if considering from the result obtained when the clearance a is set to 0.2 mm, there is a need to set the area of the connecting portion to at least 8.00 mm² or more, preferably 9.0 mm² or more, in order to prevent the generation of flow mark. Note that in FIG. 5, a provisional rib formed by the provisional rib portion is denoted by 101′.

### Examples of the Present Invention

In the comparative examples, to enlarge the area of the connecting portion between the provisional rib portion and the cavity can be considered as a measure to prevent the generation of flow mark, but, if the width c of the provisional rib portion is enlarged, the gate-cut is difficult to be performed, and thus it is unrealistic when considering the mass production. Accordingly, in the examples of the present invention, the area of the connecting portion 17a of the provisional rib portion 17 is secured to prevent the generation of flow mark and jetting, and the corner portions of the connecting portion 17a between the provisional rib portion 17 and the cavity 14 are rounded while considering the problem regarding the gate-cut. Specifically, although the basic shape of the connecting portion 17a is a rectangular shape, the provisional rib portion 17 is machined in the die 12 so that the corner portions of the rectangular shape on the design surface side of the volume knob are rounded.

FIG. 4B shows a shape of the provisional rib portion 17 of the mold according to the examples or a provisional rib formed on the volume knob. In the examples, R portions 17b are formed on the corner portions of the connecting portion 17a in the mold by setting the clearance a, the thickness b of the provisional rib portion 17 or the connecting portion 17a and the width c shown in FIG. 4B to 0.2 mm, 1.8 mm and 5 mm, respectively, while securing 9.00 mm² of the area of the connecting portion 17a to prevent the generation of flow mark. Further, by changing the values of R, the optimum value is selected. Table 2 shows a relation between the values of R and the generation of weld lines. Note that in the volume knob molded here, the relation of “wall thickness t of molded product=clearance a+thickness b of provisional rib portion 17” is satisfied, which is the same as the comparative examples, and the reason why the width c of the provisional rib portion 17 is fixed to 5.0 mm is to make it possible to perform the gate-cut with no problem at the time of mass production, which is also the same as the comparative examples.

TABLE 2
Relation between R and weld line (examples)

| R | WELD LINE |
|---|---|
| NONE | GENERATED |
| 0.3 | GENERATED MORE OR LESS |
| 0.5 | NOT GENERATED |

As shown in Table 2, there is obtained a result indicating that under the size condition of the present examples, it is possible to prevent the generation of weld lines by setting that R=0.5. Accordingly, it can be confirmed that even in a situation where only 0.2 mm of clearance a can be secured, the generation of weld lines can be prevented by setting that R≧0.5.

Further, since no weld line is generated when the clearance a is equal to or more than 1.0 mm based on the result of the comparative examples, it can be considered that when the clearance a is 0.2 mm or more, the generation of weld lines can be securely prevented by setting that R≧0.5, and the present invention can be confirmed to be effective in a situation where only the clearance a of less than 1.00 mm can be set.

Further, it can be confirmed that in the examples, since the generation of weld lines is prevented by forming the R portions 17b while securing 9.00 mm² of the area of the connecting portion 17a of the provisional rib portion 17, both the generation of flow mark and the generation of weld lines can be prevented. Accordingly, it can be confirmed that the present invention can be particularly effectively utilized when there is a contradictory relation between the securement of clearance a and the securement of area of the connecting portion 17a of the provisional rib portion 17. In addition, it is possible to eliminate a problem regarding the gate-cut by setting the width c of the connecting portion 17a to 5.00 mm when the area of the connecting portion 17a is set to 9.00 mm².

Although the embodiment and the examples of the present invention have been described above, the present invention is not limited to the aforementioned embodiment and examples, and changes and the like can be made without departing from the scope of the present invention. For example, the shape and so on of the molded product 100 are not limited to those in the shown example, and the present invention is effectively applicable to other shapes and so on, and is capable of providing the same operations and effects as those of the above-described embodiment. Concretely, although an example in which the molded product 100 is an audio volume knob was described in the examples, the present invention is particularly effectively applicable to a part being a molded product such as, for instance, a temperature control knob in a vehicle interior, in which a plate thickness of a side wall is hard to secure.

Further, an example in which the design surface 100a of the molded product 100 is an outer surface was explained in the present embodiment, but, the present invention is also effectively applicable to a molded product in which both surfaces of a side wall correspond to the design surfaces 100a. For example, when each of clearances from the provisional rib portion 17 to the both surfaces of the side wall cannot be set to 1 mm or more, by forming all the corner portions of the connecting portion 17a between the provisional rib portion 17 and the cavity 14 in a curved shape and setting that R≧0.5, it is possible to prevent the generation of weld lines on the design surfaces of the side wall.

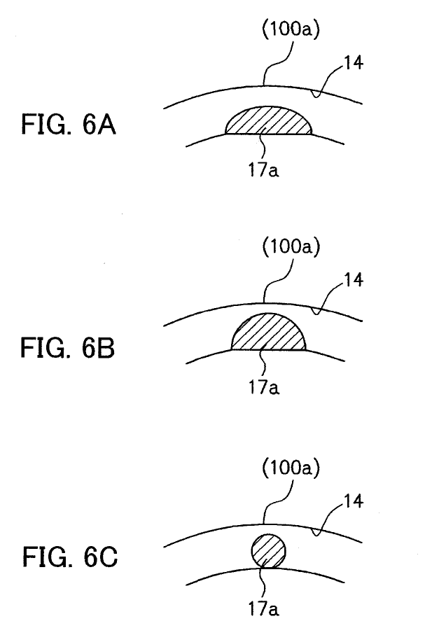

Further, explanation was made on an example in which the arc-shaped corner portions (R portions 17b) are provided on a part on the design surface 100a side as a curved shape of the connecting portion 17a of the provisional rib portion 17. As the curved shape, not only the one formed by the arc-shaped corner portions but also an elliptical shape or a circular shape and the like can be selected, for instance. Specifically, as shown in FIG. 6A or 6B, all of the connecting portion 17a on the design surface 100a side is formed in a semi-elliptical shape or semi-circular shape. Further, the connecting portion 17a may also be formed in a circular shape, as shown in FIG. 6C.

Further, although the submarine gate was employed in the present embodiment, it is also possible to employ a so-called nose gate from which molten resin is injected into the provisional rib portion 17.

According to the present invention, the quality of outer appearance of the injection-molded product can be improved with no restriction on the molding material, and thus it is possible to provide various types of injection-molded products with high commercial value.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A mold for injection molding, comprising
a provisional rib portion formed in a connected manner at a predetermined portion of a cavity to correspond to a provisional rib which is formed to project from a portion, of an injection-molded product, not serving as a design surface, and resin is injected for molding to said provisional rib portion via a gate, wherein:
an end portion of the design surface of the injection-molded product is set on a parting line, and said provisional rib portion is formed in a connected manner, on a cavity surface along the parting line, by being sided to an inner side from the design surface; and
a part or all on at least the design surface side of a connecting portion at which said provisional rib portion and the cavity are connected is formed in a curved shape.

2. The mold for injection molding according to claim 1, wherein
said provisional rib portion is formed by being sided to the inner side from the design surface by less than 1.0 mm.

3. The mold for injection molding according to claim 1, wherein
arc-shaped corner portions formed to satisfy a condition of R≧0.5 are provided to form the curved shape.

4. The mold for injection molding according to claim 2, wherein arc-shaped corner portions formed to satisfy a
condition of R≧0.5 are provided to form the curved shape.

5. The mold for injection molding according to claim 1, wherein
the injection-molded product has a side wall including the design surface, and a lower end of the side wall is set and the connecting portion is formed on a cavity surface along the parting line.

6. The mold for injection molding according to claim 2, wherein
the injection-molded product has a side wall including the design surface, and a lower end of the side wall is set and the connecting portion is formed on a cavity surface along the parting line.

7. The mold for injection molding according to claim 3, wherein
the injection-molded product has a side wall including the design surface, and a lower end of the side wall is set and the connecting portion is formed on a cavity surface along the parting line.

8. The mold for injection molding according to claim 4, wherein
the injection-molded product has a side wall including the design surface, and a lower end of the side wall is set and the connecting portion is formed on a cavity surface along the parting line.

9. The mold for injection molding according to claim 1, wherein
the gate is a submarine gate or a nose gate.

10. A manufacturing method of an injection-molded product for injecting resin for molding to a provisional rib portion via a gate, the provisional rib portion being formed in a connected manner at a predetermined portion of a cavity to correspond to a provisional rib which is formed to project from a portion, of the injection-molded product, not serving as a design surface, the method comprising
performing injection molding by using a mold for injection molding having the provisional rib portion formed in a connected manner, by being sided to an inner side from the design surface, on a cavity surface along a parting line on which an end portion of the design surface of the injection-molded product is set, and a connecting portion at which the provisional rib portion and the cavity are connected in which a part or all thereof on at least the design surface side is formed in a curved shape.

11. The manufacturing method of the injection-molded product according to claim 10, wherein
the mold for injection molding having the provisional rib portion that is formed by being sided to the inner side from the design surface by less than 1.0 mm is used.

12. The manufacturing method of the injection-molded product according to claim 10, wherein
the mold for injection molding in which arc-shaped corner portions formed to satisfy a condition of R≧0.5 are provided to form the curved shape is used.

13. The manufacturing method of the injection-molded product according to claim 11, wherein
the mold for injection molding in which arc-shaped corner portions formed to satisfy a condition of R≧0.5 are provided to form the curved shape is used.

14. The manufacturing method of the injection-molded product according to claim 10, wherein
the injection-molded product has a side wall including the design surface, and the mold for injection molding having the connecting portion formed on a cavity surface along the parting line on which a lower end of the side wall is set is used.

15. The manufacturing method of the injection-molded product according to claim 11, wherein
the injection-molded product has a side wall including the design surface, and the mold for injection molding having the connecting portion formed on a cavity surface along the parting line on which a lower end of the side wall is set is used.

16. The manufacturing method of the injection-molded product according to claim 12, wherein
the injection-molded product has a side wall including the design surface, and the mold for injection molding having the connecting portion formed on a cavity surface along the parting line on which a lower end of the side wall is set is used.

17. The manufacturing method of the injection-molded product according to claim 13, wherein
the injection-molded product has a side wall including the design surface, and the mold for injection molding having the connecting portion formed on a cavity surface along the parting line on which a lower end of the side wall is set is used.

18. The manufacturing method of the injection-molded product according to claim 10, wherein
the mold for injection molding having the gate that is a submarine gate or a nose gate is used.
